(19) United States
(12) Patent Application Publication
(10) Pub. No.: US 2024/0104975 A1
(43) Pub. Date: Mar. 28, 2024

(54) SYSTEM AND METHOD FOR DETECTING AND EVALUATING BURSTS OF DRIVER PERFORMANCE EVENTS

(71) Applicant: Bendix Commercial Vehicle Systems LLC, Avon, OH (US)

(72) Inventors: Andreas U. Kuehnle, Strängnäs (SE); Karl H. Jones, Fullerton, CA (US)

(73) Assignee: Bendix Commercial Vehicle Systems LLC, Avon, OH (US)

(21) Appl. No.: 17/953,617

(22) Filed: Sep. 27, 2022

(51) Int. Cl. G07C 5/08; G07C 5/04

(52) U.S. Cl. CPC G07C 5/0816; G07C 5/04

(57) ABSTRACT

The present disclosure describes implementations of systems and methods that detect and evaluate bursts of driver performance events. In one form a system includes at least one processor configured to: receive vehicle performance information from at least one of a controller, a sensor, or another system of a vehicle; evaluate a performance of a driver based on the received vehicle performance information and record a plurality of driver events associated with the performance of the driver; analyze the plurality of driver events and identify a burst subset of driver events based on at least one of a time of each driver event or a spacing between proximate driver events of the plurality of driver events; and alert the driver to a degradation of driving performance based on the identified burst subset of driver events.

### BACKGROUND

It is often considered normal behavior for a driver of a vehicle to make a mistake due to inattention or external traffic factors. However, when a driver makes multiple mistakes in a short period of time, it is considered abnormal behavior. This is especially true when a driver of a vehicle regularly makes a number of mistakes within a short period of time. These regular bursts of driver mistakes can be an indication that the driver is fatigued or otherwise somehow incapacitated.

### SUMMARY OF THE DISCLOSURE

The present disclosure describes implementations of system and methods that detect and evaluate bursts of driver performance events. Based on the evaluation of the bursts of the driver performance events, a system may alert the driver to a degradation in their driving performance and/or automatically adjust operations of a vehicle to account for the degradation in driver performance.

In one form, the present disclosure includes a system comprising a memory and at least one processor configured to execute instructions stored in the memory. The at least one processor is further configured to receive vehicle performance information from at least one of a controller, a sensor, or another system of a vehicle, evaluate a performance of a driver of the vehicle over a trip based on the received vehicle performance information, and record a plurality of driver events associated with the performance of the driver.

Additionally, the at least one processor is configured to analyze the plurality of driver events and identify a burst subset of driver events of the plurality of driver events based on at least one of a time of each driver event or a spacing between proximate driver events of the plurality of driver events, and to alert the driver to a degradation of driving performance based on the identified burst subset of driver events.

In another form, the present disclosure includes a method in which at least one processor receives vehicle performance information from at least one of a controller, a sensor, or another system of a vehicle and evaluates a performance of a driver of the vehicle over a trip based on the received vehicle performance information and recording, with the at least one processor, a plurality of driver events associated with the performance of the driver.

The at least one processor evaluates the plurality of driver events and identifies, with the at least one processor, a burst subset of driver events of the plurality of driver events based on at least one of a time of each driver event or a spacing between proximate driver events of the plurality of driver events, and alerts the driver to a degradation of driving performance based on the identified burst subset of driver events

### BRIEF DESCRIPTION OF THE DRAWINGS

FIG. 1 is a schematic illustration of an exemplary system environment in which one form of a system may operate that is configured to detect and evaluate bursts of driver performance events.

FIG. 2 is a flow chart of one form of a method for detecting and evaluating bursts of driver performance events.

FIG. 3 is a graph illustrating lane departure warning event gaps sizes that occur chronologically in time over three trips of a driver.

### DETAILED DESCRIPTION OF THE DRAWINGS

The present disclosure describes implementations of systems and methods that detect and evaluate bursts of driver performance events. Based on the evaluation of the bursts of the driver performance events, a system may alert the driver to a degradation in their driving performance and/or automatically adjust operations of a vehicle to account for the degradation in driver performance.

A burst driver event detection and reporting system may be configured to collect and provide event-based data corresponding to detected driver and/or vehicle related events occurring while the driver operates the vehicle. The event-based data can include vehicle and/or driver related data collected from components of, or components interacting with, the burst driver event detection and reporting system, including but not limited to vehicle devices, sensors and/or systems.

The components may include one or more driver facing cameras configured such that the field of view of the camera(s) captures a view the driver of the vehicle, and/or a view of other areas of the cabin, such as the driver controls of the vehicle while driving and non-driver passenger areas. Other cameras may be configured to capture other scenes relative to the vehicle, including but not limited to scenes in front of the vehicle, behind the vehicle, to either side of the vehicle, etc.

The components may further include vehicle devices, sensors and/or systems configured to provide non-video data, including non-video event-based data corresponding to driver and/or vehicle related events. Such components may include one or more microphones, independent or in connection with the cameras, configured to capture audio recordings of areas of the cabin and/or other vehicle areas (e.g., engine noise, etc.).

Accordingly, the burst driver event detection and reporting system can detect, in real time, the driver and/or vehicle related events from the collected event data. The event data therefore can include data from which events can be detected will be appreciated, but can also include data that corresponds to the detected event but is not used to detect the event. The events and/or the event data can be recorded, stored, reported to, collected by, or otherwise communicated internally and/or externally by the burst driver event detection and reporting system

Examples of events that may be detected and/or reported to/collected by the burst driver event detection and reporting system include but are not limited to: safety events, for example and without limitation, excessive acceleration, excessive braking, exceeding speed limit, excessive curve speed, excessive lane departure, lane change without turn signal, loss of video tracking, LDW system warning, following distance (i.e., headway) alert, forward collision warning, collision mitigation braking, collision occurrence, etc., and non-safety events, for example and without limitation, the driver logging in/out of a vehicle telematics system, the driver/passenger entering/leaving the vehicle, the driver/passenger occupying/vacating the bunk area, the driver occupying/vacating the driver seat, the vehicle engine being on/off, the vehicle gear being in park/drive, the parking brake being on/off, etc. Non-safety events may also include theft events, for example and without limitation, the presence of an unauthorized occupant accessing the vehicle, etc.

The burst driver event detection and reporting system may use event data collected directly from vehicle devices, sensors, and/or systems, which may include event data collected from an analysis of vehicle video, to generate event datasets that correspond in time with one or more detected events. Event data generated for a detected event may be associated with captured video frames whose timeline spans or overlaps the time when the event was detected/collected. Event data generated from an event determined from processing of captured vehicle video may at least be associated with the video from which it was generated, but may also be associated with other captured video frames whose timelines span or overlap the time when the event was detected/collected (in these scenarios, the time may be calculated based on the video frame or frames from which the event object was derived).

The burst driver event detection and reporting system may be further configured to collect and provide performance-based data corresponding to detected performance indicators characterizing driving performance during the driving excursion. Similar to the event-based data, the performance-based data can include vehicle and/or driver related data collected from components of, or components interacting with, the burst driver event detection and reporting system, including but not limited to vehicle devices, sensors and/or systems. The burst driver event detection and reporting system may also similarly use the performance-based data to detect performance events, as a particular type of driver and/or vehicle related event, and to generate associated datasets that correspond in time with one or more detected events.

Accordingly, the components, individually and collectively, may be configured to detect, in real time, the performance indicators (and/or performance events), and/or to report such performance indicators (and/or performance events) to the detection and reporting system. Examples of performance indicators include but are not limited to: following distance (i.e., headway), driving smoothness, driver hand positioning (e.g., gestures), driver head position, fatigue metrics, vigilance and reaction time measurements, etc., and any other indicator tending to characterize driving performance—particularly with respect to potentially impaired and/or enhanced driving performance due to, for example, distraction, inattention, increased focus, co-piloting, or other behavior.

The burst driver event detection and reporting system may further be configured to control one or more vehicle systems in response to detected events. Examples of such control include but are not limited to: providing one or more types of warnings (e.g., driver assistance system warnings, warnings to passengers in the cabin that the driver requires assistance, etc.), intervening in the operation of the vehicle (e.g., to initiate corrective action, to activate harm mitigating features, to assume autonomous control, etc.), setting driver authorizations (e.g., via vehicle telematics, etc.), and alerting remote locations/devices (e.g., backend servers, dispatch center computers, mobile devices, etc.) of such events. A variety of corrective actions may be possible and multiple corrective actions may be initiated at the same time.

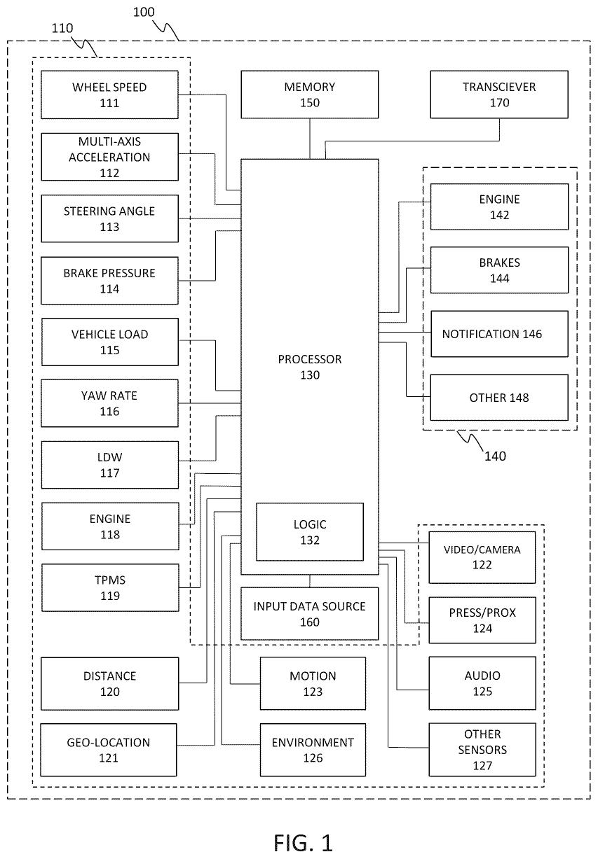

FIG. 1 is a block diagram of an environment in which a burst driver event detection and reporting system 100 may operate. A burst driver event detection and reporting system 100 may be adapted to detect a variety of operational parameters and conditions of a vehicle and a driver's interaction therewith (i.e., event-based data, performance-based data, etc.) and, based thereon, to determine if a driving and/or vehicle event has occurred (e.g., if one or more operational parameter/condition thresholds has been exceeded). The data related to detected events (i.e., event-based data or data sets) may then be stored and/or transmitted to a remote location/device (e.g., backend server, dispatch center computer, mobile device, etc.), and one or more vehicle systems can be controlled based thereon.

The burst driver event detection and reporting system 100 may include one or more devices or systems 110 for providing vehicle and/or driver related data, including data indicative of one or more operating parameters or one or more conditions of a vehicle, its surroundings and/or its cabin occupants. The burst driver event detection and reporting system 100 may, alternatively or additionally, include a signal interface for receiving signals from the one or more devices or systems 114, which may be configured separate from system 100. For example, the devices 110 may be one or more sensors, such as but not limited to, one or more wheel speed sensors 111, one or more acceleration sensors such as multi-axis acceleration sensors 112, a steering angle sensor 113, a brake pressure sensor 114, one or more vehicle load sensors 115, a yaw rate sensor 116, a lane departure warning (LDW) sensor or system 117, one or more engine speed or condition sensors 118, and a tire pressure (TPMS) monitoring system 119. The burst driver event detection and reporting system 100 may also utilize additional devices or sensors, including for example a forward distance sensor and/or a rear distance sensor 120 (e.g., radar, lidar, etc.) and/or a geo-location sensor 121. Additional sensors for capturing driver related data may include one or more video sensors 122 and/or motion sensors 123, pressure or proximity sensors 124 located in one or more seats and/or driver controls (e.g., steering wheel, pedals, etc.), audio sensors 125, or other sensors configured to capture driver related data. The burst driver event detection and reporting system 100 may also utilize environmental sensors 126 for detecting circumstances related to the environment of the driving excursion, including for example, weather, road conditions, time of day, traffic conditions, etc. Other sensors 127, actuators and/or devices or combinations thereof may be used or otherwise provided as well, and one or more devices or sensors may be combined into a single unit as may be necessary and/or desired. For example, biometric sensors may be included for detecting biometric data of the vehicle occupants.

The burst driver event detection and reporting system 100 may also include a logic applying arrangement such as a controller or processor 130 and control logic 132, in communication with the one or more devices or systems. The processor 130 may include one or more inputs for receiving data from the devices or systems. The processor 130 may be adapted to process the data and compare the raw or processed data to one or more stored threshold values or desired averages or value ranges, or to process the data and compare the raw or processed data to one or more circumstance-dependent desired value, so as to detect one or more driver and/or vehicle related events.

The processor 130 may also include one or more outputs for delivering a control signal to one or more vehicle control systems 140 based on the detection of the event(s) and/or in response to vehicle and/or driver related data. The control signal may instruct the systems 140 to provide one or more types of driver assistance warnings (e.g., warnings relating to braking, obstacle avoidance, driver performance, passenger performance, etc.) and/or to intervene in the operation of the vehicle to initiate corrective action. For example, the processor 130 may generate and send the control signal to an engine electronic control unit 142 or an actuating device to reduce the engine throttle and slow the vehicle down. Further, the processor 130 may send the control signal to one or more vehicle brake systems 144 to selectively engage the brakes (e.g., a differential braking operation). A variety of corrective actions may be possible and multiple corrective actions may be initiated at the same time. It will be understood that such corrective actions need not be contemporaneous with detected events and/or event data, and may, additionally or alternatively, be responsive to one or more historical records of detected events and/or event data. The corrective actions may precede an anticipated driver behavior change or predicted event or change of circumstances.

The vehicle control components may further include brake light(s) and other notification devices 146, which may be configured to provide warnings and/or notifications externally to the vehicle surroundings and/or internally to the vehicle occupants. Example warnings and/or notifications include: headway time/safe following distance warnings, lane departure warnings, warnings relating to braking and or obstacle avoidance events, warnings related to driver performance, warnings related to passenger performance, and any other type of warning or notification in furtherance of the embodiments described herein. Other vehicle control systems 148 may also be controlled in response to detected events and/or event data.

The burst driver event detection and reporting system 100 may also include a memory portion 150 for storing and accessing system information, such as for example the system control logic 132. The memory portion 150, however, may be separate from the processor 130. The sensors 110, controls 140 and/or processor 130 may be part of a preexisting system or use components of a preexisting system.

The burst driver event detection and reporting system 100 may also include a source of vehicle-related input data 160, which may be indicative of a configuration/condition of the commercial vehicle and/or its environmental circumstances (e.g., road conditions, geographic area conditions, etc.). The processor 130 may sense or estimate the configuration/condition and/or environmental circumstances of the vehicle based on the input data, and may select a control tuning mode or sensitivity based on the vehicle configuration/condition and/or environmental circumstances. The processor 130 may compare the operational data received from the sensors 110 to the information provided by the tuning. Such tuning may be useful, for example, where a distracting passenger is present while driving a heavily loaded vehicle. Such input data may be further useful in evaluating driving performance, as described herein. For example, the driving performance of one or more driving team may be evaluated with respect to common environmental circumstances (e.g., performance in less desirable geographic areas).

In addition, the burst driver event detection and reporting system 100 may be operatively coupled with one or more driver facing imaging devices, shown for simplicity and ease of illustration as a single driver facing camera 122 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the burst driver event detection and reporting system 100 such as a forward-facing camera 122 to record images of the roadway ahead of the vehicle. Such cameras may, for instance, indicate undesirable proximity to objects, the roadway verge, etc.

In some implementations, driver related data can be collected directly using the driver facing camera 122, such driver related data including head position, eye gaze, hand position, postural attitude and location, or the like, within the vehicle. In addition, driver identity and/or presence can be determined based on facial recognition technology, body/posture template matching, and/or any other technology or methodology for making such determinations by analyzing video data.

In operation, the driver facing camera 122 may capture video data of an interior of a vehicle cabin that includes a face of a driver. The video data may be captured on a continuous basis, or in response to a detected event. Such data may comprise a sequence of video frames with separate but associated sensor data that has been collected from one or more on-vehicle sensors or devices, as detailed herein.

The burst driver event detection and reporting system 100 may also include a transmitter/receiver (transceiver) module 170 such as, for example, a radio frequency (RF) transmitter including one or more antennas for wireless communication of data and control signals, including control requests, event-based data, performance-based data, vehicle configuration/condition data, or the like, between the vehicle and one or more remote locations/devices, such as, for example, backend servers, dispatch center computers, and mobile devices, having a corresponding receiver and antenna. The transmitter/receiver (transceiver) module 170 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 130 may be operative to select and combine signals from the sensor systems into event-based data and/or performance-based data representative of higher-level vehicle and/or driver related data. For example, data from the multi-axis acceleration sensors 112 may be combined with the data from the steering angle sensor 113 to determine excessive curve speed event data. Other hybrid data relatable to the vehicle and/or driver and obtainable from combining one or more selected raw data items from the sensors includes, for example and without limitation, excessive braking event data, excessive curve speed event data, lane departure warning event data, excessive lane departure event data, lane change without turn signal event data, lane change without mirror usage data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, following distance event data, fuel consumption event data, ACC usage event data, and late speed adaptation (such as that given by signage or exiting). Still other hybrid data relatable to the vehicle and/or driver and obtainable from combining one or more selected raw data items from the sensors includes, for example and without limitation, driver out of position event data, passenger out of position event data, driver distracted event data, driver drowsy event data, driver hand(s) not on wheel event data, passenger detected event data, wrong driver event data, seatbelt not fastened event data, driver cellphone use event data, distracting passenger event data, mirror non-use event data, unsatisfactory equipment use event, driver smoking event data, passenger smoking event data, insufficient event response event data, insufficient forward attention event data. The aforementioned events are illustrative of the wide range of events that can be monitored for and detected by the burst driver event detection and reporting system 100, and should not be understood as limiting in any way.

The burst driver event detection and reporting system 100 may further include a bus or other communication mechanism for communicating information, coupled with the processor 130 for processing information. The system may also include a main memory 150, such as random access memory (RAM) or other dynamic storage device for storing instructions and/or loaded portions of a trained neural network to be executed by the processor 130, as well as a read only memory (ROM) or other static storage device for storing other static information and instructions for the processor 130. Other storage devices may also suitably be provided for storing information and instructions as necessary or desired.

In at least some implementations, the burst driver event detection and reporting system 100 of FIG. 1 is configured to execute one or more software systems or modules that perform or otherwise cause the performance of one or more features and aspects described herein. Computer executable instructions may therefore be read into the main memory 150 from another computer-readable medium, such as another storage device, or via the transceiver 170. Execution of the instructions contained in main memory 150 may cause the processor 130 to perform one or more of the process steps described herein. In some implementations, hard-wired circuitry may be used in place of or in combination with software instructions to implement the invention. Thus, implementations of the example embodiments are not limited to any specific combination of hardware circuitry and software.

Methods for detecting and evaluating bursts of driver performance events, such as those described below, may be performed within the environment described above in conjunction with FIG. 1. It will be appreciated that the described methods may be performed with burst driver event detection and reporting systems integrated in whole or in part in a vehicle, a handheld device of a driver such as a mobile phone or tablet and/or in servers of a fleet control system.

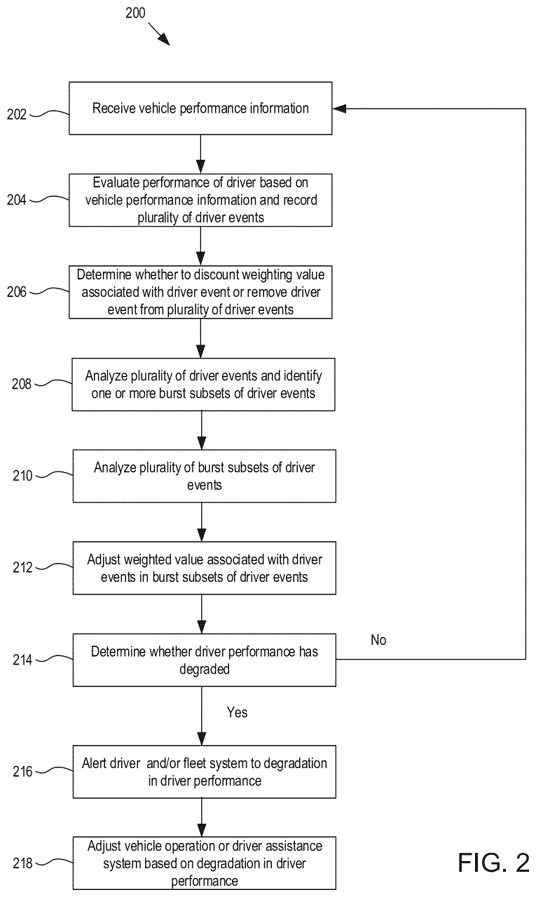

FIG. 2 is a flow chart 200 of one form of a method for detecting and evaluating bursts of driver performance events.

At step 202, a processor of a burst driver event detection and reporting system, such as those described above in conjunction with FIG. 1, receive vehicle performance information from at least one of a controller, a sensor, or another system of a vehicle. In some implementations, the vehicle performance information may include a speed of the vehicle, an acceleration of the vehicle (positive or negative), a lane departure warning of the vehicle, a forward collision warning of the vehicle, a driver action associated with vehicle, a video from a perspective of the vehicle, or a forward distance alert of the vehicle.

At step 204, the processor evaluates a performance of a driver of the vehicle over a trip based on the received vehicle performance information and records a plurality of driver events associated with the performance of the driver. Driver events may be events that potentially indicate poor driver performance. In some implementations, a rate of events per mile or per hour may be used to characterize driver performance.

In some implementations, as part of step 204, the processor detects a driver event that indicates poor driver performance based on at least one of a speed of the vehicle, an acceleration of the vehicle, a lane departure warning of the vehicle, a forward collision warning of the vehicle, a driver action associated with vehicle, a video from the perspective of the vehicle, or any other information collected at a vehicles that is indicative of poor driver performance. The processor then records the detected driver event as one of the plurality of driver events.

At step 206, the processor determines whether to discount a weighting value associated with a driver event or remove a driver event from the recorded plurality of driver events based on one or more driver event criteria, wherein the one or more driver event criteria are based on at least one of a width or curvature of a road, a condition of a road, a condition of road lane markings, a weather or visibility condition at a time of the potential driver event, a level of traffic congestion, a geographic location where the potential driver event occurs, or any other type of information that may have an influence on an ability of a driver to safely operate the vehicle. One of skill in the art will appreciate that factors like these give context to a driver event and may justify or explain at least in part why driver events have occurred that would otherwise indicate poor driving performance.

Each driver event may be associated with a weighting value that is utilized in analyzing the driver events to identify a significance of a driver event. In some implementations, all driver events are initially associated with the same value. However, in other implementations, different driver events are initially associated with different values. For example, a driver event associated with a lane departure warning may be valued different from a driver event associated with a collision warning. By discounting or otherwise adjusting a weighting value associated with a driver event or removing a driver event from the plurality of driver events based on driving criteria such as those listed above, the processor changes the impact of driver events that are at least partially explained by external factors rather than poor driving performance in comparison to the same driver event that is not explained by external factors.

At step 208, the processor analyzes the plurality of driver events and identifies one or more burst subsets of driver events of the plurality of driver events based on at least one of a time of each driver event or a spacing between proximate driver events of the plurality of driver events. In some implementations, the processor identifies a burst subset of driver events as a group of driver events of the plurality of driver events where each driver event occurs within a defined time of a next proximate driver event.

At step 210, the processor analyzes the plurality of burst subsets. For example, the processor may analyze the plurality of burst subsets to determine at least one of a frequency with which the burst subsets of the plurality of burst subsets of driver events occur; an average number of driver events within the burst subsets of the plurality of burst subsets of driver events; a maximum number of driver events within the burst subsets of the plurality of burst subsets of driver events; when a first burst subset of the plurality subsets occurs within the trip; or whether there is an increase in frequency or a decrease in frequency within or with which the burst subsets of driver events occur as time into the trip increases.

A frequency with which the burst subsets of the plurality of burst subsets of driver events occur, such as bursts per mile or bursts per hour, is generally a measure of overall driver fatigue, where a higher frequency of burst subsets indicates higher driver fatigue. A typically measure of a frequency of burst subsets for a driver that is not fatigued is 0.001 bursts of driver events per mile.

An average number of driver events within the burst subsets of the plurality of burst subsets of driver events is generally a measure of a degree of driver fatigue. Burst subsets are a set of closely spaced driver events. Short burst subsets with relatively few driver events may occur by chance, but longer burst subsets with more driver events are less likely to be due to chance. An average number of driver events within the burst subsets is thus indicative of a degree of driver fatigue. Longer bursts of driver events with a greater number of driver events occur on average later during a trip, when fatigue may be assumed to be greater than earlier in the trip. As driver events are mistakes, and if a driver quickly corrects the mistake, resulting in a short burst of driver events, then the driver is not very fatigued. However, when a driver generates a long burst with a persistent series of mistakes that are not corrected, the driver is likely more fatigued.

A maximum number of driver events within the burst subsets of the plurality of burst subsets of driver events generally indicates where a sensor in a vehicle is malfunctioning and causing driver events in the data. Significantly long bursts of driver events are often an indication of sensor malfunctions, or are generated due to non-standard conditions such as narrow roads or construction sites, where it is very difficult to stay in lane. Accordingly, in some implementations, a processor may only process subsets of driver events that include a defined range in a number of driver events, such as 2-8.

When a first burst subset of the plurality burst subsets occurs within the trip also indicates driver fatigue. On average, shorter burst subsets of driver events occur earlier in a trip and longer burst subsets of driver events occur later in a trip. Typical times to a first burst subset of driver events in a trip is 2-4 hours. When the first burst subset of driver events of any kind occurs is thus a first indication of fatigue, particularly if it is a longer burst subset of driver events, and hence unlikely to be due to chance.

Whether there is an increase in frequency or a decrease in frequency within or with which the burst subsets of driver events occur as time into the trip increases generally indicates whether this is an increase in driver fatigue or a decrease in driver fatigue. An increase in frequency with which burst subsets of driver events occur into the trip is indicative of an increase in driver fatigue.

One of skill in the art will appreciate that burst subsets of driver events, with their repeated, close, spacings between driver events are of interest because vehicle accidents or ‘incidents’ typically have a timescale of between 10-20 seconds. With records of vehicle accidents or incidents of greater length, the processor may analyze the accident or incident, as well as actions and/or events that take place before or after the accident or incident (their prequel and sequel). Some burst subsets may go up to 60-120 seconds for example and include events that are more than just a single accident/incident. Accordingly, when burst subsets are longer than a typical 10-20 seconds of a vehicle accident or incident, it is evidence that a longer, more persistent, process is occurring such as driver fatigue in comparison to a driver who is distracted that would likely result in a single driver event or a burst subset of driver events that is shorter in length. For burst subsets of driver events that are more than an upper limit of 120 seconds, for example, the burst subsets are often a result of pure chance dominating the driver events within the burst subset. Accordingly, it will be appreciated that burst subsets of driver events that are typically indicative of driver fatigue include driver events that are repeated and closely spaced without being too close to each other, where the duration of the burst subset is long enough to indicate that the burst subset is more than chance.

One of skill in the art will further appreciate that a 5-gap burst of events may extend to 5 times 120 seconds in length if the fundamental burst rule is that events must be spaced at most 120 seconds from the previous event or the next event. However, it is possible that the 120 second value would not apply to every gap. Furthermore, in some implementations, a maximum gap size may be reduced to 60 seconds, which may result in bursts of driver events being detected less often. Accordingly, it will be appreciated that a choice of maximum gap size is thus a compromise between a detection likelihood and a false alarm rate.

In some implementations, as part of step 210, the processor may analyze the plurality of burst subsets of driver events to identify key events and a driver's performance as indicated within the plurality of burst subsets after the occurrence of key events. For example, the processor may analyze the plurality of burst subsets and identify a pattern that after a burst of lane departure warnings, there is regularly a large deterioration in a longitudinal driving performance of the driver. Examples of longitudinal driver events that may regularly occur after the identified burst of lane departure warning include excessive curve speed, excessive braking, forward collision warning, collision mitigation braking, electronic stability warning, or roll stability warning. In other implementation, the processor may identify other key events and subsequent patterns that may be used to notify a driver or a fleet control system and/or to adjust an operation of a vehicle based on deteriorating performance of the driver.

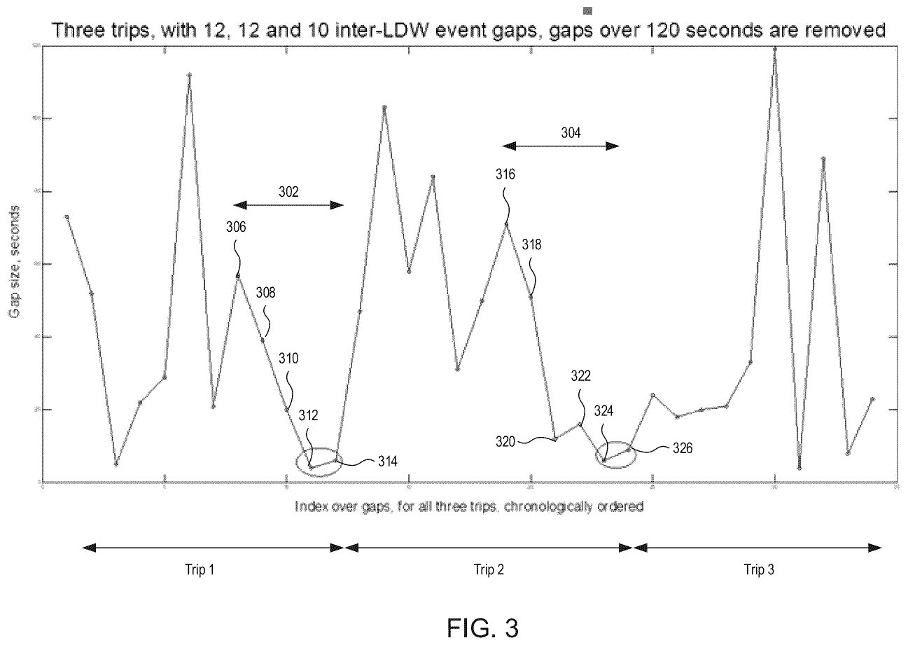

FIG. 3 is a graph illustrating lane departure warning event gaps sizes that occur chronologically in time over three trips of a driver. In FIG. 3, the x-axis is an index over gaps between lane departure warning events, chronologically ordered, and the y-axis is a gap size between lane departure warning events, in seconds. It will be appreciated that an index is an integer that identifies an event or a gap between events in a cluster thereof. For example, a first gap is index 1, a second gap is index 2, and so on. In analyzing driving events, it is of interest whether the gaps between driving events are generally getting shorter (i.e., the burst of driving events are getting more frequent), and in some implementations, this may be accomplished by generally determining whether gap 2 is shorter than gap 1, gap 3 is even shorter, and so on. Considering a time the gaps occurred (the spaces between driver events, where nothing happens) is generally not helpful since doing so would repeat the information and not providing additional information. Accordingly, indices as discussed above may be used.

In analyzing the driver events illustrated in FIG. 3, the processor identifies a first key event cluster 302 that occurs late in Trip 1 and a second key event cluster 304 that occurs late in Trip 2. In the first key event cluster 302, lane departure warning driver events with gaps 306, 308, 310, 312, and 314 occur close in time with a downward trend of decreasing gap sizes between events. In the second key event cluster 304, lane departure warning driver events with gaps 316, 318, 320, 322, 324, and 326 also occur close in time with a downward trend of decreasing gap sizes between events. Accordingly, if a subsequent trip of the driver includes a burst of driver events with a similar pattern of lane departure warnings driver events, the processor may determine that the driver is likely fatigued.

It will be appreciated that while Trip 3 illustrated in FIG. 3 may also have cluster, of driving events, the gaps between the driving events in the cluster of Trip 3 have increasingly less perfect trending behavior. Because of this, the third cluster is not considered as the large swings and hence the correlation coefficient relating the index to the gaps size is too low. The analysis of the driving events for identifying key event clusters may look for enough correlation in the driving events, with a downward trend, and a sufficient number of points in the cluster. Additionally, in some implementations, the analysis may require the final point(s) in the key event cluster reach a low enough value, e.g. that point 312 or 314 is less than a threshold.

Referring again to FIG. 2, at step 212, the processor may adjust a weighted value associated with one or more burst subsets of the plurality of subsets of driver events based on the analysis of the plurality of burst subsets. In some implementations, certain events are considered more important than others. For instance, an excessive lane departure warning (xLDW) may be considered more important than a regular lane departure warning (LDW), and accordingly, the weight associated with an excessive land departure warning may be scored twice that of a normal lane departure warning. In implementations such as this where different weights are assigned to different types of events, a weight of the burst subset may also be determined based on the value of the driver events that make up the burst subset of driver events. For example, in some implementations, a weight score of a burst subset of driver events may be equal to a sum of the weighted score of the driver events that make up the burst subset. It is this weighted score of a burst subset of driver events, for example, that may be compared to a threshold to determine if a driver is fatigued.

In some implementation, the overall weighted score of a burst subset of driver events may be adjusted based on whether the determinations of step 210 of at least one of a frequency with which the burst subsets of the plurality of burst subsets of driver events occur; an average number of driver events within the burst subsets of the plurality of burst subsets of driver events; a maximum number of driver events within the burst subsets of the plurality of burst subsets of driver events; when a first burst subset of the plurality subsets occurs within the trip; or whether there is an increase in frequency or a decrease in frequency within or with which the burst subsets of driver events occur as time into the trip increases.

At step 214, the processor determines whether there has been a degradation of driving performance of the driver.

In one example, to determine whether a driver performance of the driver has degraded, the processor may compare a frequency of burst rates of driver events within the plurality of burst subsets to a frequency of burst rates of driver events for other drivers. The processor may determine a set of drivers with a highest burst rate of driver events, a set of drivers with a longest median burst length of driver events, and a set of drivers with an earliest, on average, burst of driver events. If the driver is present in more than one of the determined sets of drivers, it is indicative of a driver has many and/or early and/or long bursts of driver events that is indicative of fatigue, and the processor may determine that the driving performance of the driver has degraded when the first burst occurs during a trip.

It will be appreciated that the trending, ever more frequent (decreasing gap size with increasing index), of events within a burst subset of driver events is an optional characteristic. A comparison of when a burst subset(s) of driver events occurs within a trip relative to the usual (e.g. median) time that this occurs for the driver may be made, where earlier, longer, burst subsets of driver events are markers of fatigue as well. This is particularly true of longer burst subsets of driver events, as these while still occasionally occurring in trips, are better signifiers of fatigue than shorter burst subsets of driver events.

In another example, to determine whether a driver performance of the driver has degraded, the processor determines whether a significant fraction of driver trips show trends toward an increasing number of events associated with lane departure warnings. The processor may determine such a pattern when, over a minimum number of sufficiently long trips where driver events associated with lane departure warnings occur, a Pearson correlation model reaches a value with a large enough slope. If the correlation model shows sufficient monotonic correlation (e.g., a correlation coefficient<−0.7) and a regression curve shows a significant decline (e.g., a 50% decrease in gap size or low enough gap size values being reached during the trip or high enough hourly event rates being reached) between a trip start and later, then the processor may determine that the driver is making more mistakes as time progresses. If a sufficient percentage of driver trips shows this behavior, such as more than 25%, the processor determines that the driving performance of the driver can degrade over their trips.

In a further example, to determine whether a driver performance has degraded, the processor determines whether one or more burst subsets of driver events meet defined criteria. For example, the processor may look for a long, tightly-spaced cluster of lane departure warning, regular or excessive, that occur early in a trip. More specifically, the processor may look for a burst of lane departure warnings that are less than 120 second apart, where the burst includes at least five lane departure warnings in a row that occur in the first 15 to 45 minutes of a trip. However, it will be appreciated that other set criteria may be used.

When the processor determines at step 214 that there has not been a degradation of driving performance of the driver, the method loops to step 202 and the above-described steps are repeated and the driver continues to operate vehicles.

Alternatively, when the processor determines at step 214 that there has been a degradation of driving performance of the driver, at step 216, the processor alerts the driver and/or a fleet control system to a degradation of driving performance based on the burst subset of driver events. In some implementations, the processor may alert the driver to the degradation of driving performance based on the plurality of bust subsets and the weighted value associated with one or more burst subsets. For example, the processors may display an alert on at least one of a vehicle display or a mobile device of the driver, and may emit an alert from at least one of a vehicle audio system or the mobile device of the driver. In some of these implementations, the in-vehicle system may recognize the presence of the mobile device of the driver, for example, from its Bluetooth emanations, and push a pairing request to it. The mobile device of the driver and an audio generation chip in the in-vehicle system might then be used to deliver audible messages rather than visual ones. A similar mechanism may be applied to a Bluetooth-equipped radio in the vehicle.

At step 218, the processor may additionally adjust at least one vehicle operation or driver assistance system of the vehicle based on the degradation of driving performance as shown in the identified burst subset of driver events. For example, the processor may adjust an amount of time before a braking action that vehicle systems alert the driver to an upcoming braking action and/or the processor may increase a distance before initiation of a braking action that vehicle systems alert a driver to an upcoming braking action.

With respect to operations of the vehicle, the processor may also perform operations such as adjusting a braking performance of the vehicle or adjusting a stability performance of the vehicle. For example, the processor may adjust braking performance to begin braking earlier or more positively. Braking may be set to start once the driver has removed their foot from the gas pedal and an object is detected ahead at close range. That is, braking is anticipated and started earlier than in normal operation with a usual ‘driver must actively start to brake’ scenario. In some circumstances, the processor may further perform actions such as engaging autonomous control of the vehicle, or once stopped in a safe location, prohibiting the driver from further operating the vehicle.

FIGS. 1-3 and their accompanying description describe implementations of systems and methods that detect and evaluate bursts of driver performance events. Based on the evaluation of the bursts of the driver performance events, a system may alert the driver to a degradation in their driving performance and/or automatically adjust operations of a vehicle to account for the degradation in driver performance.

Those having ordinary skill in the art may be able to make alterations and modifications to what is described herein without departing from its spirit and scope. The present disclosure is to be considered as an exemplification of the principles of the present disclosure, and is not intended to limit the broad aspects of the present disclosure to any embodiment or implementations described herein.

In accordance with the practices of persons skilled in the art, aspects of embodiments and implementations of the present disclosure may be described with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the detailed description and corresponding figures, numerous specific details are set forth in order to provide a thorough understanding of the present disclosure. However, it should be appreciated that the disclosure may be practiced without such specific details. Additionally, well-known methods, procedures, components, and circuits have not been described in detail.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner on one or more embodiments without limitation.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

In addition, and further in accordance with the descriptions herein, the term “logic,” as used herein, particularly with respect to FIG. 1, includes hardware, firmware, software in execution on a machine, and/or combinations of each to perform a function(s) or an action(s), and/or to cause a function or action from another logic, method, and/or system. Logic may include a software-controlled microprocessor, a discrete logic (e.g., ASIC), an analog circuit, a digital circuit, a programmed logic device, a memory device containing instructions, and so on. Logic may include one or more gates, combinations of gates, or other circuit components.

The embodiments and implementations described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1. A system comprising:
a memory; and
at least one processor configured to execute instructions stored in the memory and to:
receive vehicle performance information from at least one of a controller, a sensor, or another system of a vehicle;
evaluate a performance of a driver of the vehicle over a trip based on the received vehicle performance information and record a plurality of driver events associated with the performance of the driver;
analyze the plurality of driver events and identify a burst subset of driver events of the plurality of driver events based on at least one of a time of each driver event or a spacing between proximate driver events of the plurality of driver events; and
alert the driver to a degradation of driving performance based on the identified burst subset of driver events.

2. The system of claim 1, wherein to evaluate a performance of a driver over the trip based on the received vehicle performance information and record the plurality of driver events associated with the performance of the driver, the at least one processor is configured to:
detect a driver event based on at least one of a speed of the vehicle, an acceleration of the vehicle, a lane departure warning of the vehicle, a forward collision warning of the vehicle, a driver action associated with vehicle, a video from the perspective of the vehicle, or a forward distance alert of the vehicle; and
record the detected driver event as one of the plurality of driver events.

3. The system of claim 2, where to analyze the plurality of driver events and identify a burst subset of driver events of the plurality of driver events based at least on at least one of a time of each driver event or a spacing between proximate driver events of the plurality of driver events, the at least one processor is further configured to:
determine whether to discount or remove a driver event from the plurality of driver events based on one or more driver event criteria, wherein the one or more driver event criteria are based on at least one of a width or curvature of a road, a condition of road lane markings, a weather or visibility condition at a time of the driver event, a level of traffic congestion, or a geographic location where the driver event occurs.

4. The system of claim 1, wherein to analyze the plurality of driver events and identify the burst subset of driver events of the plurality of driver events based at least on the time of each driver event and the spacing between proximate driver events of the plurality of driver events, the at least one processor is configured to:
identify as the burst subset of driver events a group of driver events of the plurality of driver events where each driver event occurs within a defined time of a next proximate driver event.

5. The system of claim 1, wherein:
to analyze the plurality of driver events and identify a burst subset of driver events of the plurality of driver events based at least one a time of each driver event or a spacing between proximate driver events of the plurality of driver events, the at least one processor is further configured to:
identify a plurality of burst subsets of driver events in the plurality of driver events, wherein for each burst subset of driver events, the driver events of that burst subset occur within a defined time of a next proximate driver event;
analyze the plurality of burst subsets to determine at least one of:
a frequency with which the burst subsets of the plurality of burst subsets of driver events occur;
an average number of driver events within the burst subsets of the plurality of burst subsets of driver events;
a maximum number of driver events with the burst subsets of the plurality of burst subsets of driver events;
when a first burst subset of the plurality subsets occurs within the trip; or
whether there is an increase in frequency or a decrease in frequency within or with which the burst subsets of driver events occur as time into the trip increases; and
adjust a weighted value associated with one or more burst subsets of the plurality of subsets of driver events based on the analysis of the plurality of burst subsets; and
the driver is alerted to the degradation of driving performance based on the plurality of bust subsets and the weighted value associated with one or more burst subsets.

6. The system of claim 1, wherein to alert the driver to a degradation of driving performance based on the identified burst subset of driver events, the processor is configured to:
provide a warning message on at least one of a mobile device of the driver or a display of the vehicle indicating the degradation of driving performance.

7. The system of claim 1, wherein the processor is further configured to:
alter one or more performance operations of the vehicle based on the identified burst subset of driver events.

8. The system of claim 1, wherein the memory and at least one processor are part of one or more servers that are external to the vehicle.

9. The system of claim 1, wherein the memory and at least one processor are part of a mobile device of the driver.

10. The system of claim 1, wherein the memory and at least one processor are integrated with the vehicle.

11. A method comprising:
receiving, with at least one processor, vehicle performance information from at least one of a controller, a sensor, or another system of a vehicle;
evaluating, with the at least one processor, a performance of a driver of the vehicle over a trip based on the received vehicle performance information and recording, with the at least one processor, a plurality of driver events associated with the performance of the driver;
evaluating, with the at least one processor, the plurality of driver events and identifying, with the at least one processor, a burst subset of driver events of the plurality of driver events based on at least one of a time of each driver event or a spacing between proximate driver events of the plurality of driver events; and
alerting, with the at least one processor, the driver to a degradation of driving performance based on the identified burst subset of driver events.

12. The method of claim 11, wherein evaluating a performance of a driver over the period of time of the trip based on the received vehicle performance information and record the plurality of driver events associated with the performance of the driver comprises:
detecting, with the at least one processor, a driver event based on at least one of a speed of the vehicle, an acceleration of the vehicle, a lane departure warning of the vehicle, a driver action associated with vehicle, a video from the perspective of the vehicle, or a forward distance alert of the vehicle; and
recording, with the at least one processor, the detected driver event as one of the plurality of driver events.

13. The method of claim 12, wherein analyzing, with the at least one processor, the plurality of driver events and identifying a burst subset of driver events of the plurality of driver events based on at least one of a time of each driver event or a spacing between proximate driver events of the plurality of driver events comprises:
determining, with the at least one processor, whether to discount or remove a driver event from the plurality of driver events based on one or more driver event criteria, wherein the one or more driver event criteria includes at least one of a width or curvature of a road, a condition of road lane markings, a weather or visibility condition at a time of the driver event, a level of traffic congestion, or a geographic location where the driver event occurs.

14. The method of claim 11, wherein analyzing the plurality of driver events and identifying the burst subset of driver events of the plurality of driver events based on at least one of the time of each driver event or the spacing between proximate driver events of the plurality of driver events comprises:
identifying, with the at least one processor, as the burst subset of driver events a group of driver events of the plurality of driver events where each driver event occurs within a defined time of a next proximate driver event.

15. The method of claim 11, wherein:
analyzing the plurality of driver events and identifying a burst subset of driver events of the plurality of driver events based on at least one of a time of each driver event or a spacing between proximate driver events of the plurality of driver events comprises:
identifying, with the at least one processor, a plurality of burst subsets of driver events in the plurality of diver events, wherein for each burst subset of driver events, the driver events of that burst subset occur within a defined time of a next proximate driver event;
analyzing, with the at least one processor, the plurality of burst subsets to determine at least one of:
a frequency with which the burst subsets of the plurality of burst subsets of driver events that occur in a defined period of time;
an average number of driver events within the burst subsets of the plurality of burst subsets of driver events;
a maximum number of driver events with the burst subsets of the plurality of burst subsets of driver events;
when a first burst subset of the plurality subsets occurs within the trip; or
whether there is an increase in a frequency or a decrease in frequency with which the burst subsets of driver events occur as time into the trip increases; and
adjusting, with the at least one processor, a weighted value associated with one or more burst subsets of the plurality of subsets of driver events based on the analysis of the plurality of burst subsets; and
the driver is alerted to the degradation of driving performance based on the plurality of bust subsets and the weighted value associated with one or more burst subsets.

16. The method of claim 11, wherein alerting the driver to a degradation of driving performance based on the identified burst subset of driver events comprises:
providing, with the at least one processor, a warning message on at least one of a mobile device of the driver or a display of the vehicle indicating the degradation of driving performance.

17. The method of claim 11, further comprising:
altering, with the at least one processor, one or more performance operations of the vehicle based on the identified burst subset of driver events.

18. The method of claim 11, wherein the at least one processor is part of one or more servers that are external to the vehicle.

19. The method of claim 11, wherein the at least one processor is part of a mobile device of the driver.

20. The method of claim 11, wherein the at least one processor is integrated with the vehicle.

21. The method of claim 11, wherein a degradation of driving performance is determined when the identified burst subset of driver events comprises a plurality of lane departure warnings that occur within a defined period of time from a start of a trip, wherein each lane departure warning occurs within a defined time of the next proximate lane departure warning and all of the lane departure warnings of the plurality of lane departure warning occur within a defined timeframe.
